(19) United States
(12) Patent Application Publication
(10) Pub. No.: US 2009/0216862 A1
(43) Pub. Date: Aug. 27, 2009

(54) Method for the remote configuration of voice over ip telephone

(75) Inventor: Mark Jonathan Kineret Seeman, Leicester (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Thus PLC, Glasgow (GB)

(21) Appl. No.: 11/919,918

(22) PCT Filed: May 5, 2006
(86) PCT No.: PCT/GB2006/001651

§ 371 Date: Feb. 17, 2009

(30) Foreign Application Priority Data
May 5, 2005 (GB) 0509170.7

(51) Int. Cl. G06F 15/177; H04L 12/28

(52) U.S. Cl. 709/220; 370/254

(57) ABSTRACT

A method for the remote configuration of a voice over IP device (“voIP device”) on a local TCP/IP network, which can be implemented in software. The method includes a preliminary step of asking a user to select a voIP device from a list of one or more different voIP devices downloaded from a remote database using an Internet connection. The list can be regularly updated as new voIP devices come onto the market. The local TCP/IP network is analyzed to determine one or more network settings. The method then downloads a configuration module specific to the voIP device selected by the user from a remote database using the Internet connection. The configuration module is used to determine one or more configuration parameters for the voIP device. Finally, the one or more network settings and the one or more configuration parameters are used to automatically configure the voIP device for use on the local TCP/IP network.

### BACKGROUND ART

Voice over Internet Protocol (referred to below as “voIP” is a method for taking analogue audio signals generated during the course of a telephone conversation and converting them into digital data signals that can be transmitted over a TCP/IP network such as a standard Internet connection.

It is possible to use a conventional telephone for voIP by connecting the telephone to the Internet using an intermediary device called an analogue telephone adapter (ATA). The ATA takes the analogue audio signals from the telephone and converts them in to digital data signals for transmission over the Internet. It also takes the digital data signals that are received over the Internet and converts them into analogue audio signals for use by the telephone. It is also possible to use an IP telephone that is specifically designed to be connected to the Internet, either directly or by means of a wireless or WI-FL connection.

Like all devices connected to a TCP/IP network, both types of voIP device require a unique IP address. Unlike conventional telephones that only need to be plugged into a telephone socket, voIP devices also need to be properly configured before they will work. They also require some of the settings to come directly from the network service provides in the form of customer account information. This means that voIP devices can be difficult for the average home or small business user to install successfully. The applicant has found that about eight out of every ten people who try and install a voIP device themselves require some form of technical assistance usually in the form of a telephone call to a dedicated support centre. The present invention will dramatically reduce the amount of technical assistance and support by automatically installing and configuring voIP devices.

### SUMMARY OF THE INVENTION

The present invention provides a method for the remote configuration of a voIP device on a local TCP/IP network, the method including the steps of:

asking a user to select a voIP device from a list of one or more different VoIP devices downloaded from a remote database;

analysing the local TCP/IP network for which the voIP device is to be configured to determine one or more network settings;

downloading a configuration module for the voIP device selected by the user from a remote database;

executing the configuration module to determine one or more configuration parameters for the voIP device; and

using the one or more network settings and the one or more configuration parameters to automatically configure the voIP device for use on the local TCP/IP network.

The method can be implemented in computer software provided on a CD-ROM or the like and executed on a computer connected to the same local TCP/IP network as the voIP device (IP telephone or analogue telephone adapter, for example). The method males it much easier for a small business or home user to configure a voIP device without having to rely on technical assistance.

The method can further include the step of testing if the local TCP/IP network has suitable access to the Internet before the voIP device is automatically configured. If the Internet connection is not sufficiently quick or does not have the necessary degree of quality then voIP cannot be used. If the Internet connection is not suitable then the user can be informed and the remote configuration method can be selectively terminated.

The network settings can include one or more of the IP address of the gateway (router), the netmask, the IP address of the DNS server, the IP address of the SIP (Session Initiation Protocol) proxy server, the IP address of the SIP STUN server and the IP address of the SIP output proxy server associated with the local and remote TCP/IP networks and a determination of whether or not the local TCP/IP network assigns IP addresses statically or by using DHCP. A detailed description of each of the settings and parameters is given below.

The local TCP/IP network preferably includes a computer on which the software can be executed, and in this case the step of analysing the network setting of the local TCP/IP network can be carried out by first analysing the registry settings of the computer. For example, the software can read the computer's registry to list all the available network devices installed on the computer. The software then determines which network device or devices is/are currently in use by issuing a function call to the operating system. Once the software knows of an active network device it reads the IP address information for that network device from the registry. The IP address for the network device will be stored in the registry as text values.

The list of voIP devices and the configuration modules are also preferably downloaded to the computer over the Internet.

The step of executing the configuration module can include the step of carrying out one or more of the following functions: detecting whether or not a gateway (router) associated with the local TCP/IP network uses a NAT; testing the bandwidth, speed and/or quality of the Internet connection by measuring packet loss; and detecting whether or not the local TCP/IP network has a DHCP server associated with it.

If the local TCP/IP network does have a DCHP server associated with it then the step of executing the configuration module preferably includes the step of setting the IP address of the voIP device automatically in accordance with the settings of the DCHP server. Otherwise, if the local TCP/IP network does not have a DCHP server associated with it then the step of executing the configuration module preferably includes the step of allocating an unused IP address to the voIP device in a range defined by a netmask associated with the local TCP/IP network. This can be achieved in a variety of different ways, one of which is described in more detail below.

The step of detecting whether or not a gateway (router) associated with the local TCP/IP network uses a NAT can be carried out by implementing a Simple Traversal of User Datagram Protocol (UDP) Through Network Address Translators (NATs) (STUN) protocol. To do this the software will issue a series of STUN client commands (as described in Network Working Group RFC 3489 (RFC Archive)). These tell the software if the local IP address of the computer running the CD-ROM is a public IP address or a private IP address. If it is a private IP address then some form of Network Address Translation (NAT) will be employed by the gateway (router). The STUN client calculates which type of NAT is being used. If symmetrical NAT is being used then the software will need to configure the voIP device to use an SIP outbound proxy server instead of the STUN server. This is because the SIP outbound proxy server can get around the problems that are often caused by the use of a STUN server for voIP. However, the STUN server will be used wherever possible because it is more efficient in situations where there are large numbers of users. If symmetrical NAT is not being used then the voIP device will be configured to use the STUN server.

The method can also include the step of setting up a user account for the voIP device with a network service provider who will provide the user with an SIP username and SIP password. The network service provider is the company or organisation that will handle the voIP telephone calls and bill the user for them. Network service providers are commercial companies who offer customers a telephone service using voIP. They provide the user with a telephone number so that people can call them and also provide outbound call services so the user can call ordinary telephones as well as voIP devices.

The configuration parameters will vary depending on the voIP device. It may be necessary to determine if the voIP device needs some level of manual configuration by the user or is “plug and play”.

The step of using the one or more network settings and the one or more configuration parameters to automatically configure the voIP device for use on the local TCP/IP network can use any of the following protocols: ARP, HTTP, HTTPS, FTP, TFTP, SFTP, TELNET, UDP and TCP. These protocols are a selection of the more common protocols currently used to configure voIP devices but other protocols may be used now or in the future.

### DRAWINGS

FIG. 1 is a flow chart showing the steps of the method according to the present invention where the user sets up a user account with a network service provider and configures a voIP device.

The computer software for installing and configuring the voIP device (such as an analogue telephone adapter (ATA) or IP telephone) is supplied on a CD-ROM in two different commercial situations. In the first case, the software is supplied completely independently of a voIP device such as on the front cover of a magazine. In this case the software will run in a so-called “distribution mode” and may ask the user if they wish to purchase a voIP device. In the second case, the software is supplied as part of a package with a voIP device. In this case the software will run in a so-called “retail mode” and can be adapted to only recognise one or more specific types of voIP device provided by a manufacturer or retailer.

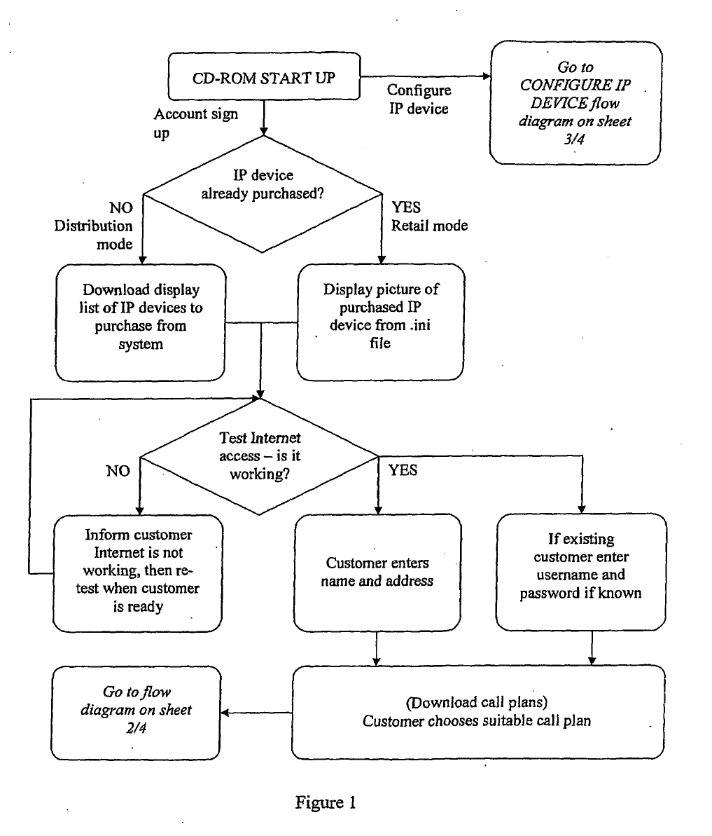

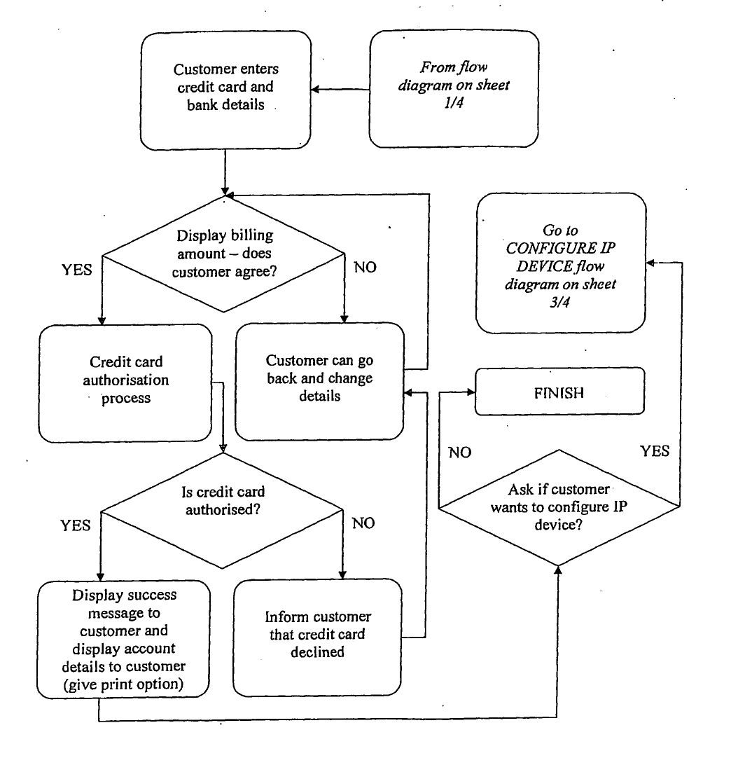

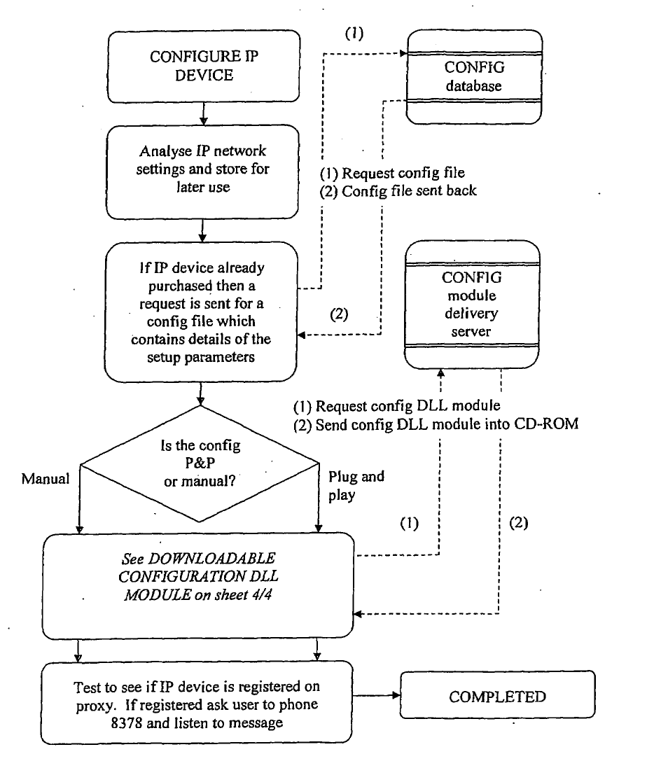

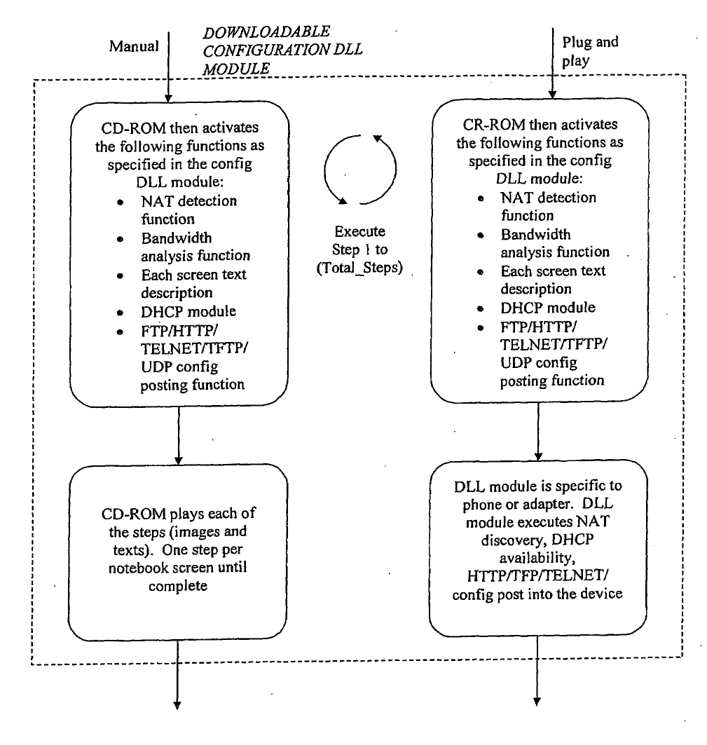

The operation of the software will now be described with reference to FIG. 1.

When the CD-ROM is loaded into the user's computer and executed it will first prompt the user to set up a voIP account or configure a particular voIP device. If the software has been supplied in “distribution mode” then the user may not have a voIP device to configure. However, this does not prevent the user from setting up an account with the network service provider. When the user purchases a voIP device at a later date, the CD-ROM can be executed for a second time and then used to configure the voIP device on their account. The CD-ROM can also be executed a second time if the user wants to set up additional accounts.

If the user wants to set up an account then the software checks to see if it is operating in “distribution mode” or “retail mode”. If it is operating in “distribution mode” then the user is displayed a list of voIP devices that can be purchased on-line. The ordering of a voIP device in this way is well known and falls outside the scope of this invention. If the software is operating in the “retail mode” then the user is shown a list (optionally accompanied by pictures) of voIP devices from which the user can select the voIP device that they want to configure. The list of voIP devices can be exhaustive (and constantly updated as new voIP devices become available) or can be limited to one or more types of voIP device from one or more manufacturers or retailers. For example, if the CD-ROM is sold with an IP telephone made by a particular manufacturer then the software can show the user a list that contains a limited number of possible IP devices to be configured, all of which are made by the manufacturer concerned. Branding and trade marks connected with the manufacturer or retailer of the voIP device can be incorporated into the software and displayed to the user during execution.

The software then carries out a test to see if a broadband (ADSL) Internet connection has been established and is working correctly. If the test is not successful then the software will display a suitable warning message to the user informing them that the Internet connection is not working. This also provides a warning to those users who try to connect a voIP device to a conventional dial-up Internet connection. The message can prompt the user to make a manual inspection of the Internet connection and then command the software to carry out a re-test. If the Internet connection cannot be made to work properly then the user can manually close down the software and take the necessary steps to correct the fault. However, if the Internet connection is working then the software will ask the user to enter their name and address, or the username and password for their account if it has been set up by the software previously.

The software may ask the user to choose a suitable call plan or tariff after downloading these to the user's computer from a central database using the Internet connection. The user is then prompted to enter their payment details such as a credit card, debit card or bank account details. The billing amount calculated using the selected call plan or tariff is displayed and the user is asked to confirm that they want to proceed. If the user declines then a different call plan or tariff can be selected. Otherwise, the software starts a payment authorisation process, which if successful allows the software to notify the user that the account with the network service provider has been properly set up.

Once the account has been set up, the software will ask the user if they want to configure a voIP device. If the user does not want to do this then the software will terminate with a suitable message. However, if the user does want to configure a voIP device then the software will proceed further with the configuration. If a user wants to configure a voIP device at a later date then they can return to the configuration process by executing the software and providing their account details.

The following attributes and parameters are needed by the software to configure the voIP device:
(i) IP address—this is the unique address that is assigned to all devices that are connected to a TCP/IP network. It is a 32-bit numeric address written in the following format “xxx.xxx.xxx.xxx”.
(ii) Netmask—this is a mask that defines the size of the local TCP/IP network to which the voIP device is connected. In the case of a small business or a home the local TCP/IP network may consist of a single computer.
(iii) Gateway IP address—this is the IP address of the router that will be used to connect the voIP device to the Internet.
(iv) Domain Name System (DNS) server address—this is the IP address of the DNS server which resolves domain names to IP addresses and vice
(v) Type of IP address assignment—this is either static or automatic. In the case of static assignment the IP address of the voIP device can be set by the software. In the case of automatic assignment there is a

Dynamic Host Control Protocol (DHCP) server on the local TCP/IP network which is used to assign IP addresses to any devices connected to the local TCP/IP network.
(vi) SIP username—this is the username of the voIP device. (usually the telephone number).
(vii) SIP password—this is the password of the voIP device (usually in the form of an alpha-numeric code).
(viii) SIP proxy server address—this is the IP address of a designated voIP server that resides on the service provider network.
(ix) SIP STUN (Simple Traversal of UDP Through NAT) server address—this is the IP address of a server that resides on the service provider network. This server allows voIP devices to use non-public IP addresses using Network Address Translation (NAT) and still function correctly.
(x) SIP outbound proxy server address—this is the IP address of a server that resides on the service provider network. The use of an outbound proxy server essentially allows the voIP device to bypass routers that employ symmetrical NAT (a particular type of NAT that often causes problems for voIP devices).

The first step in the configuration process involves an analysis of the local TCP/IP network to which the voIP device is to be connected. The analysis will determine if the local TCP/IP network assigns IP addresses statically or by using DHCP. The default IP addresses of the gateway (router), netmask and DNS server are identified by analysing the registry settings for the user's computer running the CD-ROM. These settings are stored for later use.

The software has already prompted the user choose a voIP device to be configured from a list. of voIP devices. The software then connects to a remote configuration database (labelled “CONFIG Database” in FIG. 1) that is constantly updated with information relating to the configuration requirements of new voIP devices. The remote configuration database is consistent with the list of voIP devices offered to the user. Information relating to the user-selected voIP device is transmitted from the remote configuration database to the user's computer.

The software uses the information from the remote configuration database to check if the voIP device requires a manual configuration or a “plug and play” configuration. Some voIP devices can be configured without any manual input from the user at all. These are called “plug and play”. However, some voIP devices will need some degree of manual input from the user. In this case, the software will use the computer screen to display a series of instructions to the user to tell them what information to enter and where to enter it. In both cases, the software will request a remote server to transmit a configuration DLL module to the user's computer from a remote configuration server (labelled “CONFIG Module Delivery Server” in FIG. 1) that is constantly updated with information relating to the configuration requirements of new voIP devices.

As part of the configuration routine, the software will display a configuration diagram to the user to show the user how to physically connect the IP device to the local TCP/IP network using the correct extensions or cables. The software also displays a series of screens to the user explaining the configuration steps as they take place.

The software then executes a series of functions based on the configuration DLL module to configure the voIP device. These functions include a detection function to detect if Network Address Translation (NAT) is used on the gateway router by implementing a Simple Traversal of UDP Through NAT (STUN) protocol. This function essentially determines whether or not the voIP device can be configured using a STUN server or requires a different NAT traversal system. A bandwidth analysis function is used to determine the bandwidth of the broadband Internet connection. A poor quality Internet connection will result in poor quality telephone calls when using voIP. The testing is achieved by connecting the computer to various websites using an IP socket on port 80 (standard website) and port 443 (SSL secure website). The speed and quality of the broadband connection is tested by measuring the packet response times and by sending a series of packets to a designated SIP proxy server and then calculating how many of the packets were lost. If the packets have a delivery time of more than 100 ms (round trip to the designated SIP proxy server) and more than 5% of the packets are lost then the Internet connection is not suitable for voIP.

The software analyses the registry settings of the user's computer to see if it has an automatic IP address. If this is the case then the software will check to see if the local TCP/IP network has a Dynamic Host Control Protocol (DHCP) server. If a DHCP server is available on the local TCP/IP network then the IP address of the voIP device must be set to automatic. If a DHCP server is not available then the software will find an unused IP address in the range defined by the netmask. This is carried out by creating a list of potential IP addresses within the range then sending each one of these IP addresses some packets to see if they are returned. If they are returned then the software assumes that there is a device on this IP address so it is already in use. The lowest IP address that does not get a response is assumed to be available and this is reported to the user. The user is then given an opportunity to select a different IP address and assign other settings manually, but this is only recommended for an advanced user.

Finally, the software electronically configures the settings of the IP device such as the IP address of the netmask, default gateway (router), DNS server, SIP proxy server, and SIP STUN server, the phone name, SIP username and SIP password. The configuration can use any of the following protocols: ARP, HTTP, HTTPS, FTP, TFTP, SFTP, TELNET, UDP or TCP. These protocols are employed by the software in different circumstances depending on how the specific voIP device has been designed by its manufacturer. For example, an IP telephone may employ a webpage administration and the configuration values must therefore be sent into the IP telephone using Hyper Text Transfer Protocol (HTTP). Because the software has the ability to use all of the common protocols it can be used to configure voIP devices from a diverse range of manufacturers.

Once the software has collected together all the information, parameters and settings needed to configure the voIP device, the configuration DLL module sends configuration commands to the voIP device using a method suited to the individual voIP device. For example, if the voIP device is configured using HTTP then the software will emulate a user logging onto the web interface of the voIP device and will insert values into the voIP device's webpage. It will save these settings and reboot the voIP device. Each configuration DLL module is a separate program that executes within the main software and can therefore be designed to emulate the manual configuration of the voIP device using the protocols mentioned above.

Once the configuration process is complete and the voIP device is working properly, the software will terminate with an appropriate message. The voIP device can be tested by the user to male sure it is registered on the SIP proxy server by dialling a pre-selected telephone number and waiting for a recorded voice message.

1. A method for the remote configuration of a voice over IP device on a local TCP/IP network, the method including the steps of:
asking a user to select a voice over IP device from a list of one or more different voice over IP devices downloaded from a remote database;
analyzing the local TCP/IP network for which the voice over IP device is to be configured to determine one or more network settings;
downloading a configuration module for the voice over IP device selected by the user from a remote database;
executing the configuration module to determine one or more configuration parameters for the voice over IP device; and
using the one or more network settings and the one or more configuration parameters to automatically configure the voice over IP device for use on the local TCP/IP network.

2. A method according to claim 1, further comprising the step of testing if the local TCP/IP network has suitable access to the Internet before the voice over IP device is automatically configured.

3. A method according to claim 1, wherein the network settings include one or more of the IP address of the gateway (router), the netmask, the IP address of the DNS server, the IP address of the SIP proxy server, the IP address of the SIP STUN server and the IP address of the SIP output proxy server associated with the local TCP/IP network or a remote TCP/IP network, and a determination of whether or not the local TCP/IP network assigns IP addresses statically or by using DHCP.

4. A method according to claim 3, wherein the local TCP/IP network includes a computer and wherein the step of analyzing the network setting of the local TCP/IP network is carried out by analyzing the registry settings of the computer.

5. A method according to claim 4, wherein the list of voice over IP devices and the configuration module are downloaded to the computer over the Internet.

6. A method according to claim 2, wherein the step of executing the configuration module includes the step of carrying out one or more of the following functions:
detecting whether or not a gateway (router) associated with the local TCP/IP network uses a NAT;
testing the bandwidth, steed and/or quality of the Internet connection; and detecting whether or not the local TCP/IP network has a DHCP server associated with it.

7. A method according to claim 6, wherein if the local TCP/IP network does have a DCHP server associated with it then the step of executing the configuration module includes the step of setting the lIP address of the voice over lIP device automatically in accordance with the settings of the DCHP server.

8. A method according to claim 6, wherein if the local TCP/IP network does not have a DCHP server associated with it then the step of executing the configuration module includes the step of allocating an unused lIP address to the voice over IP device in a range defined by a netmask associated with the local TCP/IP network.

9. A method according claim 6, wherein the step of detecting whether or not a gateway (router) associated with the local TCP/IP network uses a NAT is carried out by implementing a STUN protocol.

10. A method according claim 1, further comprising the step of setting up a user account for the voice over 1 device with a network service provider to provide an SIP username and SIP password.

11. A method according claim 1, wherein the step of using the one or more network settings and the one or more configuration parameters to automatically configure the voice over IP device for use on the local TCP/IP network uses any of the following protocols: ARP, HTTP, HTTPS, FTP, TFTP, SFTP, TELNET, UDP and TCP.

12. Computer software for carrying out the method according claim 1 when executed on a computer connected to the local TCP/IP network.
